(19) United States
(12) Patent Application Publication
(10) Pub. No.: US 2024/0224951 A1
(43) Pub. Date: Jul. 11, 2024

(54) FISH FARMING CAGE UTILIZING LIVE BIOMASS AS DRIVING FORCE FOR WATER EXCHANGE

(71) Applicant: Seafarming Systems AS, Stavanger (NO)

(72) Inventor: Alf Reidar Sandstad, Stavanger (NO)

(73) Assignee: Seafarming Systems AS, Stavanger (NO)

(21) Appl. No.: 18/560,310

(22) PCT Filed: May 16, 2022
(86) PCT No.: PCT/NO2022/050110

§ 371 Date: Nov. 10, 2023

(30) Foreign Application Priority Data
May 14, 2021 (NO) 20210606

(51) Int. Cl. A01K 61/10

(52) U.S. Cl. CPC A01K 61/10

(57) ABSTRACT

A fish cage is for farming of fish, the fish cage having one of a water-tight outer wall and a close to water-tight outer wall and the outer wall is form stable, an entrance for water into the fish cage and an outlet for water out of the fish cage at a lower portion. The fish cage is adapted for an active water flow from an inlet at an upper portion through the fish cage to the outlet, and the fish cage is adapted to keep a shoal of fish with a negative buoyancy in a region within the water flow, such that the shoal of fish creates the water flow. A method is for exchanging water in a fish cage by utilizing the fish is also described.

### CROSS-REFERENCE TO RELATED APPLICATIONS

This application is the U.S. national stage application of International Application PCT/NO2022/050110, filed May 16, 2022, which international application was published on Nov. 17, 2022, as International Publication WO 2022/240296 in the English language. The International Application claims priority of Norwegian Patent Application No. 20210606, filed May 14, 2021. The international application and Norwegian application are both incorporated herein by reference, in entirety.

### FIELD

The present invention concerns farming of fish within a fish cage. More particularly the invention concerns a fish cage that utilize fish with a different density than the water, and fish swimming in circles, to establish and drive a water flow.

### BACKGROUND

Raising fish in captivity for food is well known and has a long history. The development has been from raising fish in earth ponds and confinements made of net which has been placed in rivers, lakes, and sea water. Confinements made of net is widely used in commercial fish farming. Typically, a floating fish pen comprises a confinement made of a net to form sidewalls and a bottom and a buoyancy body which circumference the net to keep the fish pen floating in the surface. The fish pen may also comprise a walkway around the net and a handrail. The handrail may support a jumping net that extends from the water surface to the handrail to block fish from jumping out of the fish pen. An advantage with a confinement made of a net is that water may flow freely through the fish cage.

The fish need oxygen, and fresh water carries oxygen. Water may carry harmful organisms such as fish parasites and toxic algae. It is known to position skirt around a fish pen to avoid that water with harmful organisms flow through the fish pen. The skirt may be a fine meshed net or a water-tight tarpaulin. Although this may protect the fish within the fish pen from parasites and algae, it reduces the water flow and the oxygen content in the water within the pen to unacceptable low levels. Oxygen or air may be added to the water within the fish pen to compensate for this. Alternatively, oxygen rich water may be pumped into the fish pen by a propeller, an impeller or similar, or by air lift.

A semi-closed fish pen has a permanent water-tight upper wall and an open lower part formed by a net. The lower portion of the wall may be formed by the net, and the bottom is formed by a net. The water-tight upper wall may be formed by a cloth such as a tarpaulin, or the water-tight upper wall may be formed by a rigid material such as fibreglass or steel. To maintain fish health and sufficient oxygen, water is pumped into the upper part of the fish pen either laterally into the fish pen or vertically up to the upper part through one or several pipes within or on the outside of the fish pen. The pipes have their inlet below the water-tight upper wall.

A closed fish pen has a permanent water-tight wall and bottom. To maintain fish health and sufficient oxygen, sea water is pumped laterally into the upper part of the fish pen. Water is supplied through one or several external pipes with the inlet below the bottom of the cage, as not to pump parasites into the fish pen. The water-tight wall may be made of a cloth such as a tarpaulin. The hydrostatic pressure inside the water-tight confinement is slightly above the surrounding hydrostatic pressure to maintain the shape of the tarpaulin, i.e., the water level within the fish pen is slightly higher than the water level outside the fish pen. The water-tight wall may be made of a rigid material such as fibreglass or steel. Water flows out of the fish pen through openings that may be positioned on the wall or at the bottom. The amount of water flowing in equals the amount of water flowing out.

Fish require oxygen rich water to grow and thrive. Traditional pumps for this purpose comprise a propeller or impeller within a pump hose, an inlet pipe and an outlet pipe. The inlet pipe is fed with surrounding deep water and preferably with water without parasites. In the pipes or in the pen, the water is supplemented with additional oxygen. The outlet pipe may be provided with a nozzle to create a circular water flow within the fish pen as some fish species prefer to swim against the local current. The sea water pumped into the pen provide a minor portion of the oxygen the fish need. The major portion is provided by adding oxygen to the water. This requires equipment and power use, which add cost and risk in case of power or equipment failure.

Known commercial closed fish pens typically have a volume of 30,000 m³. Stocking density of fish is at a maximum 50 kg fish per m³ of water. Maximum density is rarely reached. For purpose of calculation 40 kg fish/m³ is realistic. The fish is supplied with oxygen through a combination of pumping a limited amount of fresh oxygen rich water into the pen and adding extra oxygen to the water. Commercial closed fish pens typically have four to eight inlet pipes each provided with a pump. Typical flow speed of water within the inlet pipes is of 3 m/s. Total pumping capacity is of 6-10 m³/s. At a pumping rate of 10 m³/s in a cage of 30,000 m³ stocked with 40 kg fish/m³, the amount of water pumped through the pen is typically 0.5 liter/kg fish/minute. A rule of thumb is that Atlantic salmon needs 5 liter/kg fish/minute with fresh sea water to thrive without oxygenation. If the oxygen level in the water is low due to various reasons, more than 5 liter/kg/minute is needed. The commercial closed fish pen provides around 1/10 of the needed water exchange and compensate with adding extra oxygen to the water. This requires equipment and power use, which adds cost and risk in case of power or equipment failure.

Closed fish pens aim to collect sludge by sedimentation and pump the wastewater from the bottom of the pen to the surface for treatment and sludge deposit. Such sludge collection requires a limited water flow for the sedimentation.

### SUMMARY

The invention has for its object to remedy or to reduce at least one of the drawbacks of the prior art, or at least provide a useful alternative to prior art.

The object is achieved through features, which are specified in the description below and in the claims that follow.

In the description the term fish pen and the term fish cage have the same meaning. A semi-closed fish cage as described herein, has a water-tight outer wall or close to watertight outer wall. A portion of the bottom is covered by a net. Portions of the lower portion of the outer wall may be covered by a net.

More specifically, one aim of the invention is to avoid sea lice infestation in a fish cage while also having sufficient water exchange to avoid oxygenation of the water within the fish cage in daily operation.

The invention will first be described in relation to known theory and with reference to salmonid fish (Salmo spp., Oncorhynchus spp.). Most fish at most depths will have a negative buoyancy. The invention is therefore referencing fish with different density from the water as fish with negative buoyancy. Salmonoid fish have negative buoyancy except close to the surface and with a fully filled swim bladder.

For fish, buoyancy is a fundamental driver of vertical distribution and swimming energetics. Fish have evolved several mechanisms to decrease body density, which include reduced muscle and bone mass, increased lipid levels, and the development of an internal gas filled sac, the swim bladder.

Many fish species have a swim bladder. Salmonoid fish have a swim bladder as well. The specific density of farmed Atlantic salmon (Salmo salar) with empty swim bladder is typically between 1043 and 1065 kg/m³.

Full strength sea water has a density of approximately 1025 kg/m³ (ρ_{sw}). The swim bladder constitutes approximately 5% of the body volume of a live farmed salmonoid fish. The pressure at the water surface is approximately 1 atm, and at a water depth of 10 m, the pressure is approximately 2 atm.
Boyle's law: P₁V₁=P₂V₂

According to Boyle's law the volume of the swim bladder of a salmonoid fish at 10 m depth is therefore reduced to approximately 2.5% of the body volume. The loss in volume corresponds to 25 ml/dm³ body volume. In other words, a fish of 1 kg will experience a negative buoyancy of approximately 25 g at 10 m depth. The individual fish compensates for this by on average swimming with an ascending angle.

A standing stock or biomass of 100,000 kg (100 metric tons) of fish that on average swim at 10 m depth within a fish pen, will collectively experience a negative buoyancy of 2,500 kg (2.5 tons). Correspondingly, a fish biomass of 1000 metric tons will experience a negative buoyancy of 25 tons.

Fish in a fish cage typically swim in circles. An object moving in circles have a centripetal acceleration and is affected by a centripetal force. The centripetal force in turn contributes to a water flow created by the live biomass. A skilled person will understand that not every fish within the cage need to swim in circle in order to create water flow as long as the biomass in sum swim in a circle.

A fish swimming in a circle will have a centripetal acceleration of a_{c}=v²/r.

The centripetal force will be F=ma_{c}.

For a standing stock or biomass of 1,000 metric tons made up by 200,000 fish with individual weight of 5 kg, and which on average swim with a speed of 0.5 m/s at the radius of gyration, the centripetal force will be 17 kN.

Knowing depth and radii of the fish cage we translate the force to pressure by Bernoulli's equation: p+0.5ρ_{sw}v²+β_{sw}gh=constant; (v=(2p/ρ_{sw})^{0.5}).

The fish is assumed stocked in a cage according to FIG. 4 with fish in an inner compartment. Assuming the outer radius is 23 m, inner radius 20 m and depth is 20 m. The velocity potential will equal 0.6 m/s. The water flow will equal the velocity times the inlet area, as long as outlet area >inlet area. The water flow is then 244 m³/s. A rule of thumb says that farmed salmon needs 5 liter oxygen rich water/kg fish/min to grow. The example will yield approximately 14.6 liter/kg/min, but some of the water flow will be recirculated oxygen depleted sea water due to the proximity of the entrance and the outlet. Expecting a 20% recirculation the salmon will have 11.7 liter/kg/min. Increasing the outer radius will increase the water flow.

A water density difference between the entrance and outlet will create a pressure for the water flow created by the fish to overcome. This example includes a height between the entrance and the outlet of 2 m and a density difference of 0.1 kg/m³ of the sea water at 2 m height difference. Which gives a pressure of 1 Pa.

$$Δ p = 0.5 {Δρ}_{sw} Δ hg$$

For simplicity and understanding the calculations shown do not include losses and friction, so the result is not conservative. At what depth and radius the fish swim, the fish' fat percentage, swim bladder percentage, density difference, etc, are factors that make the matter complex.

The velocity potential component from the negative buoyancy in the example is significantly larger than the velocity potential component from the centripetal acceleration. With the fish in the inner compartment the effect from the centripetal acceleration will detract from the effect from the negative buoyancy. With the fish in the outer compartment the effect from the centripetal acceleration will add to the effect from the negative buoyancy.

The principle has been verified by experiments in a full-scale fish cage with somewhat different parameters than in the example. Measured velocity potential, and other findings are reproduced in CFD (Computational Fluid Dynamics) analysis.

FIGS. 1A-E illustrates in general terms flow dynamics within a form stable container within a water column. The form stable container comprises a water-tight sidewall and a water-tight bottom. A submerged inlet is positioned at an upper part of a sidewall. An outlet is positioned at a lower part of the sidewall and below the inlet. The sidewall protrudes above a water surface and the container is open towards the air. The internal area of the container towards the air is Aₛ.

In FIG. 1A, a living biomass with a negative buoyancy is positioned below the outlet. The living biomass is able to maintain its vertical position within the container by their swimming action. Due to the negative buoyancy, the pressure within the lower part of the container below the outlet is increased to counteract the force due to the negative buoyancy.

The water level of the water surface within the container is equal to the water level on the outside of the container. There is no flow of water through the container from the inlet towards the outlet.

In FIG. 1B, a living biomass with a negative buoyancy is positioned above the inlet. The living biomass is able to maintain its vertical position within the container. Due to the negative buoyancy of the fish, the biomass creates a downward force F_{D} acting on the fluid. To maintain steady state, i.e., a constant volume of water and biomass within the container, the water level within the container is lower than on the outside of the container. The height difference is ΔH₁·F_{D}=ΔH₁ρ_{sw}·g·Aₛ. There is no flow of water through the container from the inlet towards the outlet.

In FIG. 1C, a living biomass with a negative buoyancy is positioned below the inlet and above the outlet. The living biomass is able to maintain its vertical position within the container. Due to the negative buoyancy of the fish, the biomass creates a downward force F_{D}. The force F_{D} creates an internal overpressure forcing water out of the outlet. At the same time a sub-pressure within the form stable container creates a water flow into the container through the inlet. If assuming no friction losses, the areas formed by the container cross section, the inlet, and the outlet results in pressure variations (Bernoulli) along a flow line from the inlet to the outlet. A height difference ΔH₂ between the water surface outside of the container and within the container is hence a result of these three areas and the driving force/pressure generated by the fish.

If, the living biomass depicted in FIG. 1C has a positive buoyancy it would create an upward force, and the water would flow in the opposite direction. The inlet and outlet will then swap position.

FIGS. 1A-F show a container that is open towards air. However, the same principles apply to a container that is closed at the top, except for at extreme conditions where a major sub-pressure is created. The whole container may therefore be submerged.

FIGS. 1A-F show an idealized container. The skilled person will know that there will be local effects and that the viscosity of the fluid, i.e. the water, will have an impact. E.g., the living biomass above the inlet, see FIG. 1B, may contribute somewhat to the flow through the container.

Water-tight material means that no water will penetrate through the material. The material may be a metal or a plastic. Close to water-tight material means that the material has a pore structure or a is a woven material, but the material has sufficient resistance to a water flow through the material to create a hydrodynamic pressure difference over the material.

According to the gist of the invention fish is raised with no need for oxygenation in daily production by utilizing the fish to create the necessary water exchange. This is obtained by a fish cage comprising a large inlet cross-sectional area and a large outlet crosssectional area. In this context a large area means substantially larger than the inlet area, i.e. internal diameter of the inlet pipes, of a commercial closed pen and the outlet from the commercial pen.

The outlet and entrance are both typically positioned in the lower portion of the fish cage. A certain amount of the oxygen depleted outlet water will flow back into the fish cage through the entrance. To compensate for this the fish cage must be designed to allow for more than 5 liter water/kg fish/minute. For purpose of calculation an aim of 7 liter water/kg fish/minute is set.

The invention is defined by the independent patent claims. The dependent claims define advantageous embodiments of the invention.

In a first aspect the invention relates more particularly to a floating fish cage for farming of fish, the fish cage comprises:
one of a water-tight outer wall and a close to water-tight outer wall, and the outer wall is form stable;
an entrance for water into the fish cage;
an outlet for water out of the fish cage at a lower portion; and
buoyancy means.

The fish cage comprises at least two compartments, the at least two compartments comprise a fish compartment and at least one passage;

the at least one passage comprises the entrance and an inlet at an upper portion;

the fish compartment comprises the outlet and is in fluid communication with the at least one passage through the inlet;

the fish compartment is adapted to keep a shoal of fish in a region between the inlet and the outlet, said shoal of fish comprises fish with one of the characteristics:
negative buoyancy,
swimming in circle, and
negative buoyancy and swimming in circle;

the fish compartment and the passage are circular shaped and positioned concentrically, and an inner wall between the fish compartment and the passage is connected to a bottom of the fish compartment, such that the shoal of fish creates a water flow from the entrance through the passage and the fish compartment and to the outlet.

By circular shaped is also meant other geometries such as square, pentagonal, hexagonal, sevenangled, octagonal, and decagonal.

In a second aspect the invention relates more particularly to a floating fish cage for farming of fish, the fish cage comprises:
one of a water-tight outer wall and a close to water-tight outer wall, and the outer wall is form stable;
an entrance for water into the fish cage;
an outlet for water out of the fish cage at a lower portion; and
buoyancy means,
The fish cage comprises at least two compartments, the at least two compartments comprise a fish compartment and at least one passage;
the at least one passage comprises the entrance and an inlet at an upper portion; the fish compartment comprises the outlet and is in fluid communication with the at least one passage through the inlet;
the fish compartment is adapted to keep a shoal of fish in a region between the inlet and the outlet, said shoal of fish comprises fish with one of the characteristics:
   negative buoyancy,
   swimming in circle, and
   negative buoyancy and swimming in circle;
the fish compartment is circular shaped and the at least one passage is positioned outside an outer rim of the fish compartment, the outer wall forms a portion of a sidewall of the passage, such that the shoal of fish creates a water flow from the entrance through the passage and the fish compartment and to the outlet.

The buoyancy means may surround the outer wall and keep the fish cage floating on a water surface.

The fish cage may comprise:
a part of the outer wall extending above the water surface;
a form stable water-tight closed inner wall forming an upper portion, the inner wall extends from a lower portion in the fish cage, and the upper portion is positioned below a water surface within the fish cage; and
a net fastened to the upper portion and extending above a water surface within the fish cage, the net forming an inlet;
and
the entrance is formed in one of: between the outer wall and the inner wall at the lower region and in the lower part of the outer wall, and
the outlet is formed within the inner wall, such that the fish compartment is positioned within the inner wall and the passage is positioned in an annulus between the outer wall and the inner wall.

The fish cage may comprise:
a part of the outer wall extending above the water surface;
a form stable water-tight closed inner wall forming an upper portion, the inner wall extends from a lower portion in the fish cage, and the upper portion is positioned below a water surface within the fish cage; and
a net fastened to the upper portion and extending above the water surface within the fish cage, the net forming an inlet;
and
the entrance is formed within the inner wall, and
the outlet is formed in one of: between the outer wall and the inner wall at the lower region and in the outer wall, such that the fish compartment is positioned in an annulus between the outer wall and the inner wall and the passage is positioned within the inner wall.

The fish cage may comprise:
a part of the outer wall extending above the water surface;
an inner net forming a closed off volume in the middle of the fish cage; and
the entrance is formed at the bottom in the center of the fish cage;
and
the outlet is formed in one of:
between the outer wall and the inner net at the lower region, and
in the outer wall at the lower region, such that the fish compartment is positioned in an annulus between the outer wall and the inner net and the passage is positioned within the inner wall.

In some embodiments the inner wall may extend beneath the outlet. The inner wall may extend beneath the outer wall.

The entrance may be positioned on the outer wall. The fish cage may comprise a hatch, said hatch may cover the entrance. The fish cage may comprise a plurality of entrances and a plurality of hatches. The plurality of hatches may be positioned on various depths.

In some embodiments the outer annulus may be divided into a plurality of discrete vertical tubes.

The plurality of discrete vertical tubes may be provided with a plurality of hatches located at different depths and corresponding entrances. By opening and closing the hatches the depth of the active entrance can be regulated.

In a second aspect the invention relates more particularly to a method for exchanging water in a fish cage stocked with fish with one of the characteristics:
negative buoyancy;
swimming in circle
negative buoyancy and swimming in circle.

The method comprises to:
provide a fish cage as described above;
stock the fish cage with fish in a region between the inlet and the outlet;
utilize a force created by the fish to establish a water flow between the inlet and the outlet.

The fish cage may be provided with an entrance for the water flow, and the entrance corresponds with the inlet. The entrance may be positioned below the inlet, and water may flow through one of a passage and an annulus from the entrance to the inlet.

While the invention describes a distinct water entrance, a distinct water inlet and a distinct water outlet, this must be understood to mean mainly an entrance, an inlet and an outlet. Some water may enter the enclosure through an area defined as a water outlet and some water may exit the cage through an area defined as a water inlet without deviating from the scope of the invention.

In a third aspect the invention relates more particularly to using fish with a negative buoyancy to create a water flow within a fish cage between an entrance via an inlet to an outlet where the inlet is above the outlet.

In a fourth aspect the invention relates more particularly to using flow generators in addition to fish with a negative buoyancy and the circling biomass of the fish to create a water flow within a fish cage between an entrance via an inlet to an outlet where the inlet is above the outlet.

In all embodiments as described, supplementary flow generators may be placed inside the water-tight outer wall with the flow generator's center axis along the flow lines to directly support the water flow created by the biomass from the entrance via an inlet to an outlet where the inlet is above the outlet.

In all embodiments as described, supplementary flow generators may be placed inside the water-tight outer wall configured for generating a horizontal, circular water flow, indirectly supporting the water flow created by the biomass, by creating an under pressure in the center volume of the cage and an over pressure in the periphery volume towards the inside of the outer wall, further creating a water flow through the cage from the entrance via an inlet to an outlet where the inlet is above the outlet.

The flow generator may comprise a propeller, a water jet, an ejector, or a thruster. The flow generator is supplied with water from inside the water-tight outer wall in the upper portion of the cage.

While it is possible to utilize a live biomass to drive sufficient water exchange without need for other means of water exchange or oxygenation, there are instances where it could be necessary or beneficial to use additional means, temporary or permanent. Some examples are:
When there is a large difference in water density between entrance and outlet (temporary or permanent)
Cage with a substantial height between the water inlet and water outlet (permanent)
Shallow cage (permanent)
Periodic low oxygen level in the water entering the cage (temporary)
Extra large biomass at the end of a production cycle (temporary)

Combining the use of flow generators and live biomass in general to create water exchange requires fewer flow generators, less energy to operate them, and it reduces the need for redundance. If the power supply or equipment fails, the biomass creates sufficient water exchange to survive.

In the description and the claims, a form stable wall is to be understood as a wall with sufficient form stability or shape stability to withstand pressure differences between one side of the wall and the opposite side of the wall. The wall may be formed by metal such as steel or aluminium. The wall may be formed by a reinforced plastic material. The wall may be formed by a cloth such as a plastic sheet. The plastic sheet may especially be supported by a frame. The wall may be formed by a combination of such materials.

### BRIEF DESCRIPTION OF THE DRAWINGS

In the following is described examples of preferred embodiments illustrated in the accompanying drawings, wherein:

FIGS. 1A-E show schematical presentations of water flow and hydrodynamics within a form stable container stocked with fish;

FIG. 2 shows schematically and simplified a fish cage in one embodiment;

FIG. 3 shows schematically and with some more details a fish cage in an alternative embodiment;

FIG. 4 shows schematically a fish cage of two concentric compartments where a central compartment is a fish compartment and where a shoal is denied access to a surrounding compartment;

FIGS. 5A-B show schematically a fish cage in two embodiments, the fish cage comprises two concentric compartments where a central compartment is a passage and the surrounding compartment is a fish compartment, and where a shoal is denied access to the central compartment;

FIG. 6 shows the same as FIG. 5A where flow generators are positioned inside the watertight wall and the configured for creating a horizontal circular water flow;

FIG. 7 shows the same as FIG. 5A where a flow generator is positioned within a watertight inner wall and the flow generator generates an upward water current;

FIGS. 8A-B show the same as FIGS. 5A-B, in an embodiment with the outlet in the lower portion of the outer wall; and

FIG. 9 shows variations of the embodiment shown in FIG. 4, where the passage, where one embodiment for water entrance is shown to the left and an alternative embodiment for water entrance is shown to right; and

FIG. 10 shows an alternative to the fish cage shown in FIG. 9, where the passage is provided with hatches to cover the water entrances.

### DETAILED DESCRIPTION OF THE DRAWINGS

Any positional indications refer to the position shown in the figures. In the figures, same or corresponding elements are indicated by same reference numerals. For clarity reasons, some elements may in some of the figures be with-out reference numerals.

A person skilled in the art will understand that the figures are just principal drawings. The relative proportions of individual elements may also be distorted.

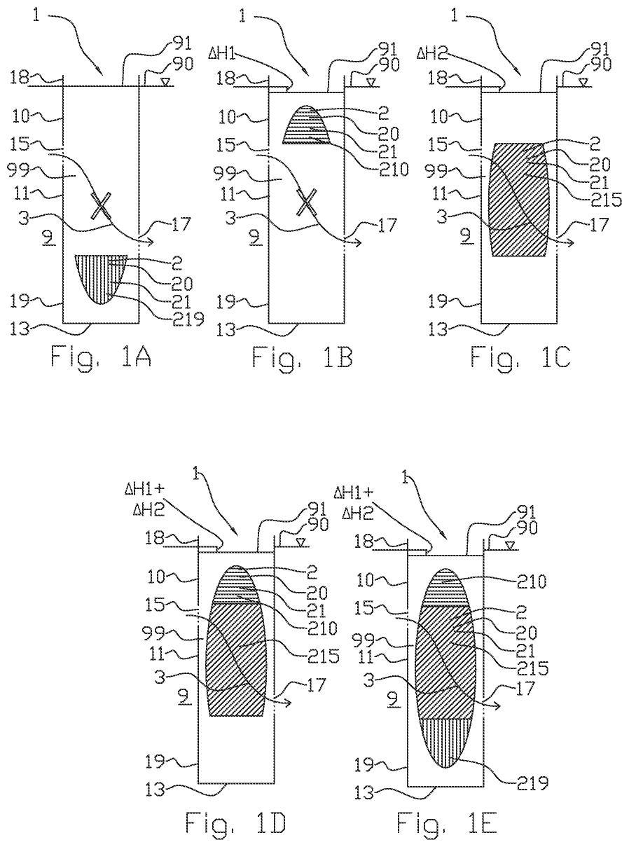

In FIGS. 1A-E, the reference numeral 1 indicates a closed, form stable container. The container 1 is adapted for raising fish 2 in a fish farming operation. The 11, a bottom container is provided with a form stable wall 13, an inlet 15 and an outlet 17. The inlet 15 is above the outlet 17. The inlet 15 is shown positioned in an upper portion of the wall 11, and the outlet 17 is shown positioned in a lower portion of the wall 11. The container 1 is positioned in a water column 9, and the container 1 may be provided with floating means (not shown) to keep the container 1 floating in the water column 9 such that a part 18 of the wall 11 extends above a water surface 90. In an alternative embodiment, the container is closed at the top, and the container 1 may rest on a ground (not shown) or the container 1 may be fully submerged in a water column 9 (not shown).

The fish 2 form a living biomass 20. The fish 2 form a shoal 21. The shoal 21 freely migrate vertically within the container 1. For purpose of clarity the shoal 21 is described as composed of an upper shoal 210, a lower shoal 219, and a middle shoal 215.

As explained in the general description, the lower shoal 219 positioned below the outlet 17 has no impact on a water flow 3 through the container 1 from the inlet 15 to the outlet 17. This is schematically shown in FIG. 1A. The upper shoal 210 positioned above the inlet 15 has also no impact on the water flow 3 through the container 1 from the inlet 15 to the outlet 17. This is schematically shown in FIG. 1B. However, the upper shoal 210 has an impact on the surface level within the open container 1 as explained in the general description. The water surface 91 within the container 1 becomes lower than the water surface 90 outside the container 1. The height difference is ΔH₁.

The impact of the middle shoal 215 is shown in FIG. 1C. The middle shoal 215 creates a water flow 3 through the container 1 from the inlet 15 to the outlet 17 as explained in the general description. In addition, the water surface 91 within the container 1 becomes lower than the water surface 90 outside the container 1. The height difference is ΔH₂ due to the pressure drop over the inlet 15 as explained in the general description.

The combined effect of the upper shoal 210 and the middle shoal 215 is shown in FIG. 1D. The water flow 3 is due to the middle shoal 215 only. The height difference between the water surface 91 inside the container 1 and the water surface 90 outside the container 1 is the sum of the impact of the upper shoal 210 and the middle shoal 215 and is Δ₁+Δ₂.

The effect of the whole shoal 21 is shown in FIG. 1E. The water flow 3 and the level of the water surface 91 inside the container 1 is the same as shown in FIG. 1D.

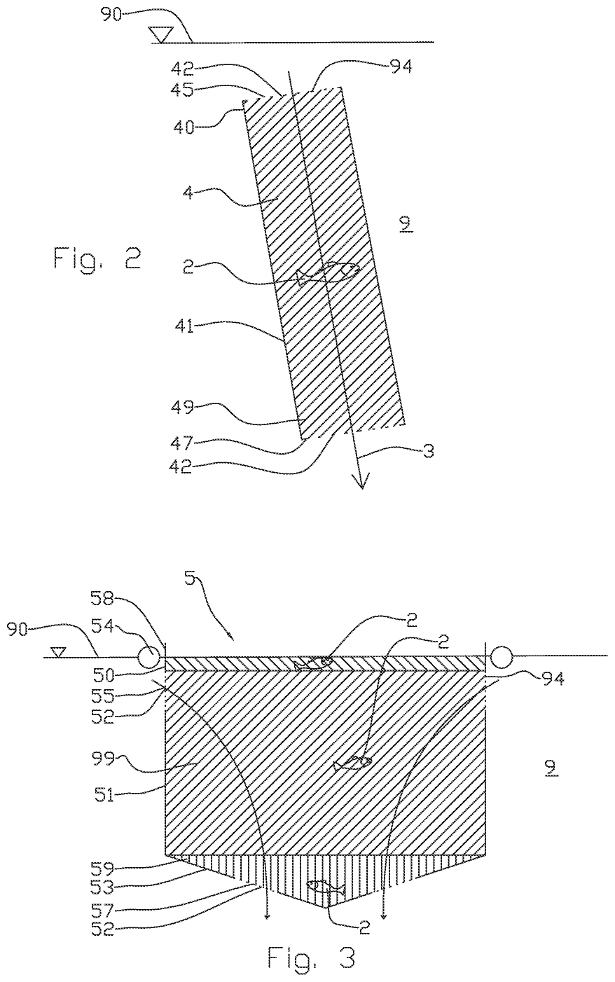

FIG. 2 shows a simplified fish cage 4 stocked with fish 2 where water exchange is carried out according to the principles shown in FIGS. 1A-1E with the inlet 15 positioned above the outlet 17 with the fish in captivity in between. The fish cage 4 comprises a form stable wall 41. The fish cage 4 is provided with an inlet 45 at the upper portion 40 and an outlet 47 at the lower portion 49. The inlet 45 forms an entrance 94. The inlet 45 and the outlet 47 is covered by a net 42 or similar to prevent that fish 2 escapes from the fish cage 4. The negative buoyancy of the fish 2 creates a water flow 3 through the fish cage 4 from the inlet 45 to the outlet 47.

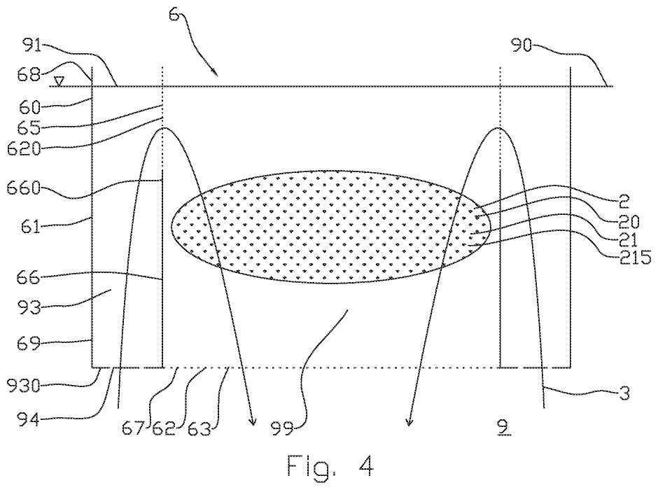

FIG. 3 shows a schematic fish cage 5 that floats on the water surface 90. The fish cage 5 is stocked with fish 2. Water exchange is carried out according to the principles shown in FIGS. 1A-1E. The fish cage 5 comprises a form stable wall 51. The fish cage 5 is provided with an inlet 55 at the upper portion 50 and an outlet 57 at the bottom 53 in the lower portion 59. The inlet 55 forms an entrance 94. The inlet 55 and the outlet 57 is covered by a net 52 or similar to prevent that fish 2 escapes from the fish cage 5. The negative buoyancy of the fish 2 creates a water flow 3 through the fish cage 5 from the inlet 55 to the outlet 57. A part 58 of the wall 51 extends above the water surface 91. The fish cage 5 is provided with buoyancy means 54 to keep it floating in the water column 9. In this embodiment the fish 2 has access to the whole interior of the fish cage 5.

FIG. 4 shows a schematic fish cage 6 that floats on the water surface 90 by buoyancy means (not shown in FIG. 4). The fish cage 6 is stocked with fish 2 which form a living biomass 20 in form of a shoal 21. Water exchange is carried out according to the principles shown in FIGS. 1A-1E. The fish cage 6 comprises a form stable wall 61. A part 68 of the wall 61 extends above the water surface 91. The fish cage 6 is provided with a form stable, water-tight inner wall 66. The inner wall 66 is continuous and forms a closed wall.

The wall 61 and the inner wall 66 form between them one or several passages 93. The passage 93 may be an annulus. An upper portion 660 of the inner wall 66 is positioned below the water surface 91 within the fish cage 6. A net 620 or similar is fastened to the upper portion 660 and extends upwards to above the water surface 91. The inlet 65 is above the upper portion 660. The net 620 blocks the fish 2 from swimming into the passage 93. A second net 930 or similar, blocks fish or other marine animals from entering the passage 93 from outside the fish cage 6 through an entrance 94, and serves as a secondary barrier for the fish 2 escaping the cage 6. The fish cage 6 is provided with an outlet 67 at the bottom 63 in the lower portion 69. The outlet 67 is covered by a net 62 or similar to prevent that fish 2 escapes from the fish cage 6. The negative buoyancy of the shoal 21 creates a water flow 3 through the fish cage 6 from the passage 93 through the inlet 65 and to the outlet 67. In this embodiment the fish 2 has access to a central part of the fish cage 6, but not to the passage or the passages 93.

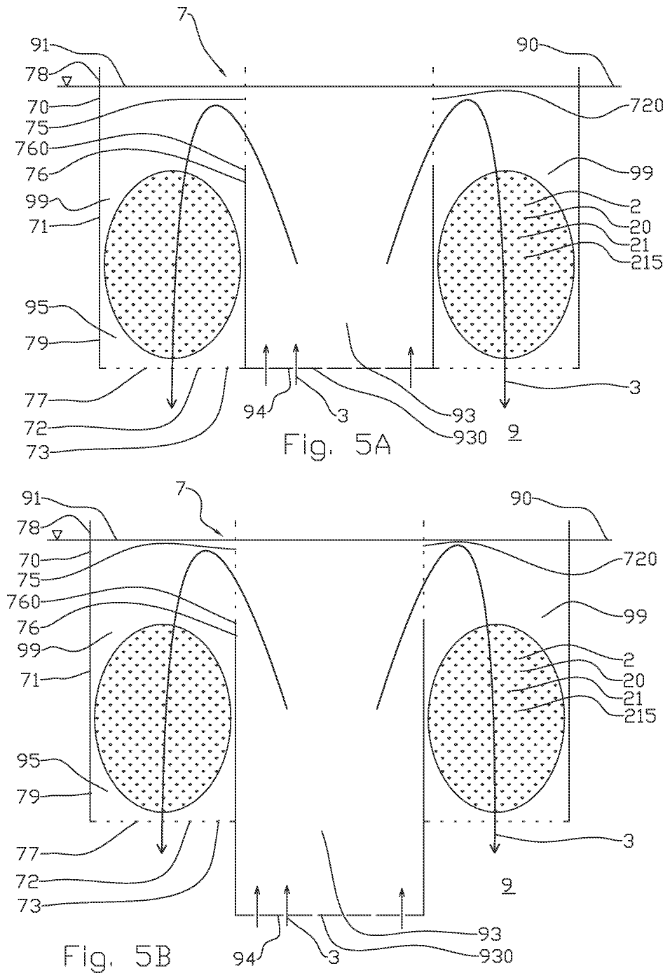

FIGS. 5A-B show a schematic fish cage 7 that floats on the water surface 90 by buoyancy means (not shown in FIGS. 5A-B). The fish cage 7 is stocked with fish 2 which form a living biomass 20 in form of a shoal 21. Water exchange is carried out according to the principles shown in FIGS. 1A-1E, and the effect of the shoal 21 swimming in circle. The fish cage 7 comprises a form stable outer wall 71. A part 78 of the outer wall 71 extends above the water surface 91. The fish cage 7 is provided with a form stable, water-tight inner wall 76. The inner wall 76 is continuous and forms a closed wall. The outer wall 71 and the inner wall 76 form between them an annulus 95. The inner wall 76 forms an internal passage 93. An upper portion 760 of the inner wall 76 is positioned below the water surface 91 within the fish cage 7. A net 720 or similar is fastened to the upper portion 760 and extends upwards to above the water surface 91. The inlet 75 is above the upper portion 760. The net 720 blocks the fish 2, which is positioned in the annulus 95, from swimming into the passage 93. A second net 930 or similar, blocks fish or other marine animals from entering the passage 93 from outside the fish cage 7 through an entrance 94, and serves as a second barrier for fish 2 escaping the cage 7. The fish cage 7 is provided with an outlet 77 at the bottom 73 in the lower portion 79. The outlet 77 is covered by a net 72 or similar to prevent that fish 2 escapes from the fish cage 7. The negative buoyancy of the shoal 21 and the effect of the shoal 21 swimming in circle, creates a water flow 3 through the fish cage 7 from the passage 93 through the inlet 75, through the annulus 95 and to the outlet 77.

The fish cage 7 is shown in one embodiment in FIG. 5A and in an alternative embodiment in FIG. 5B. In the alternative embodiment shown in FIG. 5B, the inner wall 76 extends below the bottom 73. The entrance 94 is thereby positioned deeper than the outlet 77. Thereby, effluent water from the fish cage 7 is not circulated back to the fish cage 7. In this embodiment the fish 2 has access to a peripheral part of the fish cage 7, but not to central passage 93.

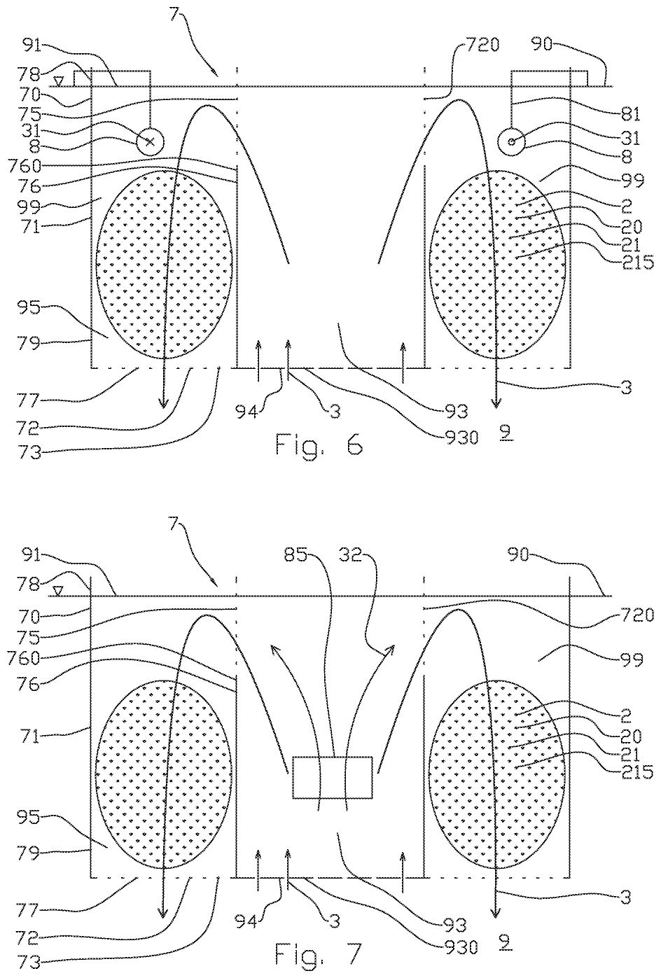

FIG. 6 shows the same schematic fish cage 7 as in FIG. 5A. In this embodiment the fish cage 7 is provided with a plurality of first flow generators 8. The water flow generators 8 are positioned in the upper part of the fish cage 7, inside the watertight outer wall 71. In one embodiment as shown in FIG. 6, each first flow generator 8 is positioned between the watertight outer wall 71 and the inlet 75, i.e. in the upper portion of the annulus 95. The first flow generator 8 is fastened to the fish cage 7 by a fastening member 81. The first flow generators 8 are configured to create a horizontal circular water flow 31 inside the watertight outer wall 71. The first flow generator 8 may comprise a propeller, a water jet, an ejector, or a thruster. The water inlet (not shown) of the first flow generator 8 is at the same level as the water outlet (not shown) of the first flow generator 8, i.e. the first flow generator 8 moves water horizontally. The water flow 31 is depicted in FIG. 6 as a small circle indicating that the water flow 31 flows in a direction towards the viewer and as a small cross indicating that the water flow 31 flows in a direction away from the viewer. In FIG. 6 this means that the water flow 31 flows clockwise when viewed from above. This circular flow of water in turn creates a hydrodynamic under pressure at the center volume of the fish cage 7 and a hydrodynamic over pressure at the peripheral volume of the fish cage 7 towards the outer wall 71. This pressure difference creates a water flow 3 through the fish cage 7 from the passage 93 through the inlet 75, through the annulus 95 and to the outlet 77. The water flow 31 from the first flow generators 8 thereby increases the water flow 3 created by the negative buoyancy of the fish and the circling of shoal 21.

FIG. 7 shows the same schematic fish cage 7 as in FIG. 5A. In this embodiment the fish cage 7 is provided with at least one second flow generator 85 positioned within the watertight inner wall 76. The at least one second flow generator 85 is positioned in the center of the fish cage 7. The second flow generator 8 may comprise a propeller, a water jet, an ejector, or a thruster. The water inlet (not shown) of the second flow generator 8 is underneath the second flow generator 85 and the water outlet (not shown) is on top of the second flow generator 85, i.e. the second flow generator 8 generates a vertical water flow 32, adding flowing water to the water flow 3 through the fish cage 7 from the passage 93 through the inlet 75, through the annulus 95 and to the outlet 77. The water flow from the second flow generator 85 adds to the water flow 3 created by the negative buoyancy of the fish and the circling of shoal 21. The skilled person will understand that necessary means for positioning the second flow generator 85 and provide energy to the second flow generator 85 are not shown.

The first flow generator 8 and the second flow generator 85 are supplementary flow generators for temporary or permanent installation, and/or for temporary or permanent operation. Examples of temporary situations where supplementary flow generators assist in maintaining sufficient water flow are:
Large difference in water density between entrance and outlet
Periodic low oxygen level in the water entering the fish cage
Extra large biomass at the end of a production cycle

Examples of permanent situations where supplementary flow generators assist in maintaining sufficient water flow are:
Large difference in water density between entrance and outlet
Shallow fish cage
Inlet or outlet cross-sectional area is less than required for sufficient water flow

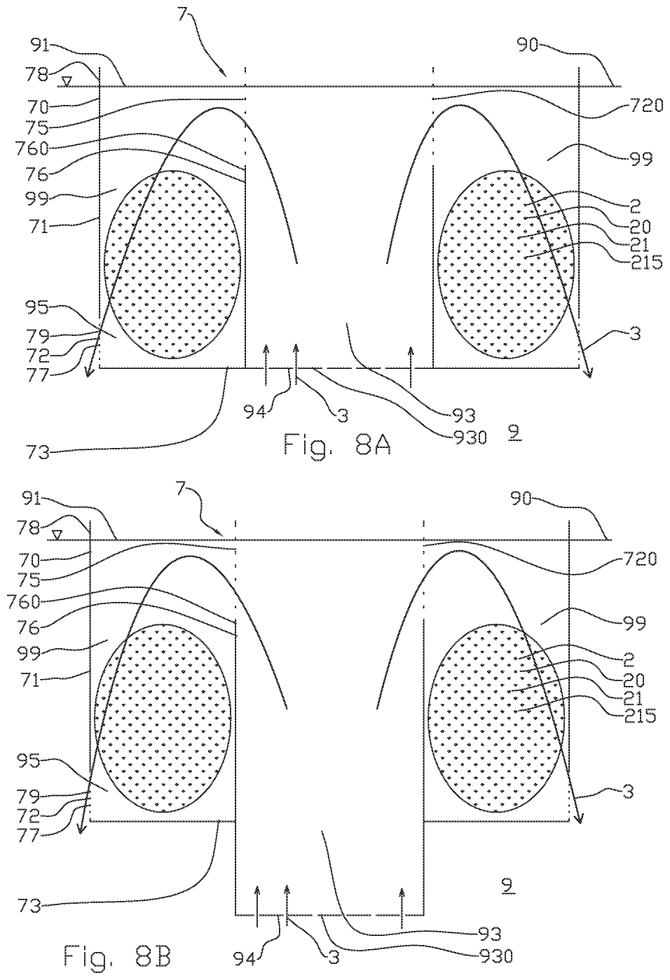

The fish cage 7 is shown in an alternative embodiment in FIG. 8A. The outlet 77 is positioned in the lower portion 79 of the outer wall 71. The fish cage 7 is shown in a further alternative embodiment in FIG. 8B. The outlet 77 is positioned in the lower portion 79 of the outer wall 71.

The fish cage 7 shown in FIG. 6 may in an alternative embodiment (not shown) have the outlet 77 positioned in the lower portion 79 of the outer wall 71 as shown in FIG. 8A. The fish cage 7 shown in FIG. 7 may in an alternative embodiment (not shown) have the outlet 77 positioned in the lower portion 79 of the outer wall 71 as shown in FIG. 8A.

In embodiments (not shown) the fish cage 7 may have the outlet 77 positioned partly in the bottom 73 and partly in the lower portion 79 of the outer wall 71.

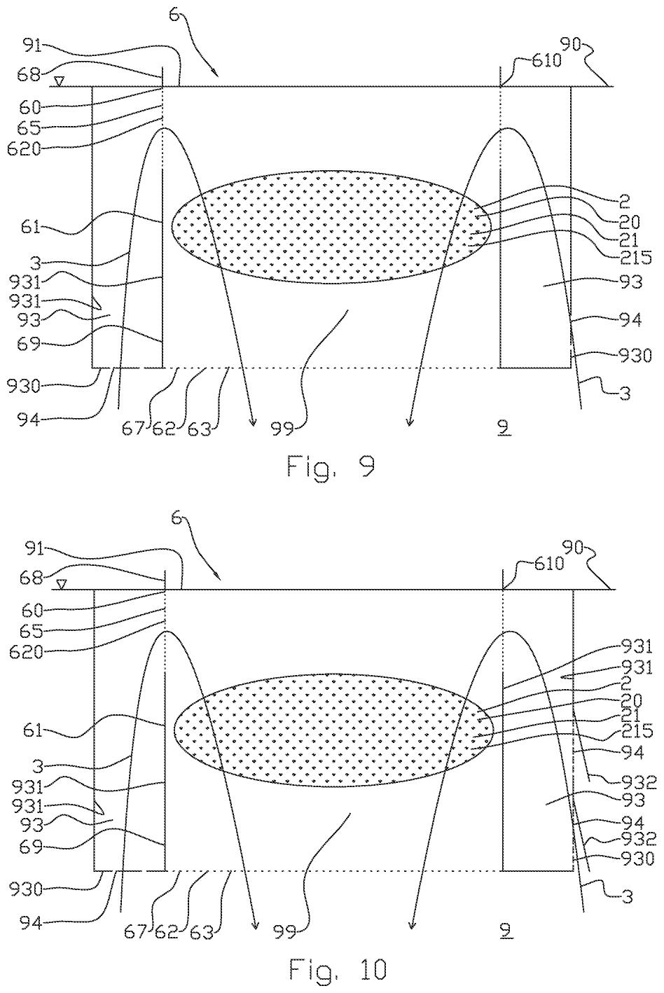

FIG. 9 shows an alternative embodiment. The fish cage 6 forms an outer rim 610. At least one passage 93 is positioned outside of the rim 610. FIG. 9 shows two passages 93. The fish cage 6 may comprise a plurality of passages 93, such as three, four, five and six passages 93. The wall 61 forms a portion of a sidewall 931 of the passage 93, such that there are no water flowing between the wall 61 and the passage 93. The passage 93 is in one embodiment provided with an entrance 94 facing downwards as shown to the left in FIG. 9. The passage 93 is in one embodiment provided with an entrance 94 in the sidewall 931 as shown to the right in FIG. 9. The passage 93 may be provided with at least one hatch 932 in the sidewall 931 as shown in FIG. 10. The hatch 932 covers the entrance 94. The passage 93 may be provided with a plurality of hatches 932 located at different depths and corresponding entrances 94 are located at different depths as shown in FIG. 10. By opening and closing the hatches 932 the depth of the active entrance 94 can be regulated.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. A floating fish cage for farming of fish, the fish cage comprising:
one of a water-tight outer wall and a close to water-tight outer wall, and the outer wall is form stable;
an entrance for water into the fish cage;
an outlet for water out of the fish cage at a lower portion; and
buoyancy means,
wherein the fish cage comprises at least two compartments, the at least two compartments comprise a fish compartment and at least one passage;
the at least one passage comprises the entrance and an inlet at an upper portion;
the fish compartment comprises the outlet and is in fluid communication with the at least one passage through the inlet;
the fish compartment is adapted to keep a shoal of fish in a region between the inlet and the outlet, said shoal of fish comprises fish with one of the characteristics:
negative buoyancy,
swimming in circle, and
negative buoyancy and swimming in circle;
the fish compartment and the passage are circular shaped and positioned concentrically, and an inner wall between the fish compartment and the passage is connected to a bottom of the fish compartment, such that the shoal of fish creates a water flow from the entrance through the pas-sage and the fish compartment and to the outlet.

2. A floating fish cage for farming of fish, the fish cage comprises:
one of a water-tight outer wall and a close to water-tight outer wall, and the outer wall is form stable;
an entrance for water into the fish cage;
an outlet for water out of the fish cage at a lower portion; and
buoyancy means,
wherein the fish cage comprises at least two compartments, the at least two compartments comprise a fish compartment and at least one passage;
the at least one passage comprises the entrance and an inlet at an upper portion;
the fish compartment comprises the outlet and is in fluid communication with the at least one passage through the inlet;
the fish compartment is adapted to keep a shoal of fish in a region between the inlet and the outlet, said shoal of fish comprises fish with one of the characteristics:
negative buoyancy,
swimming in circle, and
negative buoyancy and swimming in circle;
the fish compartment is circular shaped and the at least one passage is positioned outside an outer rim of the fish compartment, the outer wall forms a portion of a sidewall of the passage, such that the shoal of fish creates a water flow from the entrance through the passage and the fish compartment and to the outlet-.

3. The fish cage according to claim 1, wherein the fish cage comprises:
a part of the outer wall extending above the water surface;
a form stable water-tight closed inner wall forming an upper portion, the inner wall extends from a lower portion in the fish cage, and the upper portion is positioned below a water surface within the fish cage; and
a net fastened to the upper portion and extending above a water surface within the fish cage, the net forming an inlet; and
the entrance is formed in one of: between the outer wall and the inner wall at the lower region and in the lower part of the outer wall, and
the outlet is formed within the inner wall, such that the fish compartment is positioned within the inner wall and the passage is positioned in an annulus between the outer wall and the inner wall.

4. The fish cage according to claim 1, wherein the fish cage comprises:
a part of the outer wall extending above the water surface;
a form stable water-tight closed inner wall forming an upper portion, the inner wall extends from a lower portion in the fish cage, and the upper portion is positioned below a water surface within the fish cage; and
a net fastened to the upper portion and extending above the water surface within the fish cage, the net forming an inlet; and
the entrance is formed within the inner wall, and
the outlet is formed in one of: between the outer wall and the inner wall at the lower region and in the outer wall, such that the fish compartment is positioned in an annulus between the outer wall and the inner wall and the passage is positioned within the inner wall.

5. The fish cage according to claim 1, wherein the fish cage comprises:
a part of the outer wall extending above the water surface;
an inner net forming a closed off volume in the middle of the fish cage; and
the entrance is formed at the bottom in the center of the fish cage; and
the outlet is formed in one of:
between the outer wall and the inner net at the lower region, and
in the outer wall at the lower region, such that the fish compartment is positioned in an annulus between the outer wall and the inner net and the pas-sage is positioned within the inner wall.

6. The fish cage according to claim 4, wherein the inner wall extends beneath the outer wall.

7. The fish cage according to claim 1, wherein the entrance is positioned on the outer wall.

8. The fish cage according to claim 7, wherein the fish cage comprises a hatch, said hatch covers the entrance.

9. The fish cage according to claim 8, wherein the fish cage comprises a plurality of entrances and a plurality of hatches.

10. A method for exchanging water in a fish cage stocked with fish with one of the characteristics:
negative buoyancy;
swimming in circle; and
negative buoyancy and swimming in circle,
wherein the method further comprises:
providing a fish cage according to claim 1;
stocking the fish cage with fish in a region between the inlet and the outlet;
utilizing a force created by the fish to establish a water flow between the inlet and the outlet.

11. The fish cage according to claim 2, wherein the entrance is positioned on the outer wall.
